(19) United States
(12) Patent Application Publication
(10) Pub. No.: US 2017/0278123 A1
(43) Pub. Date: Sep. 28, 2017

(54) SYSTEM FOR MANAGING MEMBERSHIP, METHOD FOR MANAGING MEMBERSHIP USING REGISTRATION OF MEMBERSHIP BY USER AND APPARATUS USING THE SAME

(71) Applicant: SK Planet Co., Ltd., Gyeonggi-do (KR)

(72) Inventor: Seung-Hoon MOON, Seoul (KR)

(21) Appl. No.: 15/384,017

(22) Filed: Dec. 19, 2016

(30) Foreign Application Priority Data
Mar. 25, 2016 (KR) 10-2016-0036047

(51) Int. Cl. G06Q 30/02

(52) U.S. Cl. CPC G06Q 30/0226; G06Q 30/0255

(57) ABSTRACT

Disclosed are a membership management system, a membership management method using membership registration by a user, and an apparatus using the method. Information about a store used by a user is received from the user's terminal, whether the store is a first membership store or a second membership store registered by the user is checked, current states of use of respective second membership stores are updated based on user's usage records when the store is a second membership store not corresponding to a first membership store, and a store satisfying a condition for recommendation is recommended as a first membership store, among multiple second membership stores, based on the current states of use of the respective second membership stores. Because a frequently used store is registered as an affiliate store based on records on the customers' actual use of stores, membership advertisements and services may be effectively used.

### CROSS REFERENCE TO RELATED APPLICATION

This application claims the benefit of Korean Patent Application No. 10-2016-0036047, filed Mar. 25, 2016, which is hereby incorporated by reference in its entirety into this application.

### BACKGROUND OF THE INVENTION

1. Technical Field

The present invention relates generally to a method for managing a membership service and, more particularly, to a membership management system that is capable of recommending a store as a new membership store based on information about use of a store registered by a user, a membership management method using membership registration by a user, and an apparatus using the same.

2. Description of the Related Art

Currently, many membership services are operated such that, when customers who hold a membership visit an offline store that has joined a membership service and use a service provided there, the customers save points that can be used in the corresponding store.

However, offline stores that customers visit are not always affiliate stores or partner stores that provide such a membership service. Accordingly, when customers visit stores that do not provide a membership service, the customers cannot receive any benefit in association with the membership service, even though they buy products there. Therefore, customers want to receive membership service in stores that they often visit, but it is difficult for these stores to join a membership service in response to a request from individual customers.

Therefore, required is a new model for a membership system, configured such that information about stores from which multiple customers want to receive a membership service is collected from the customers, after which a membership service provider invites the stores to join the membership service based on the collected information, whereby the membership service may be provided to the customers in the stores that are often visited by the customers. In connection with this, Korean Patent Application Publication No. 10-2009-0000212 discloses a technology related to “System and method for coupon advertisement service.”

### SUMMARY OF THE INVENTION

An object of the present invention is to register a store recommended based on records on the customers' actual use of the store as an affiliate store to thereby make better use of membership advertisements and services.

Another object of the present invention is to provide membership benefits to users in stores that do not provide a membership service but are often visited by the users.

A further object of the present invention is to increase the sales and profits of a store by providing the owner of the store with a marketing and advertising tool specialized for the store and enabling the owner to provide better service to customers.

In order to accomplish the above object, a membership management server according to the present invention includes a first membership checking unit for receiving information about a store used by a user from a terminal of the user and checking whether the store is a first membership store; a second membership checking unit for checking whether the store is a second membership store registered by the user; a current state update unit for updating current states of use of respective second membership stores based on a use record of a user when the store does not correspond to the first membership store but is the second membership store; and a first membership recommendation unit for recommending a store satisfying a condition for recommendation as a first membership store, among multiple second membership stores registered in a store database, based on the current states of use of the respective second membership stores.

Here, the membership management server may further include a membership provision unit for providing a membership service and a membership advertisement for multiple first membership stores to the terminal when the store is a first type, providing the membership advertisement and second membership points to the terminal when the store is a second type, and providing the membership service, the membership advertisement, and the second membership points to the terminal when the store is a third type.

Here, the membership provision unit may determine that the store is the first type when the store corresponds only to the first membership store, determine that the store is the second type when the store corresponds only to the second membership store, and determine that the store is the third type when the store corresponds to both the first membership store and the second membership store.

Here, the first membership recommendation unit may select the store recommended as the first membership store from among the second membership stores corresponding to the second type.

Here, the membership management server may further include a recommendation content provision unit for generating first membership recommendation content corresponding to the store recommended as the first membership store using the current states of use of the respective second membership stores and providing the first membership recommendation content to the store recommended as the first membership store.

Here, the recommendation content provision unit may provide the store recommended as the first membership store with statistical information about customers of the store recommended as the first membership store and an advertising and marketing tool for the store recommended as the first membership store.

Here, the membership management server may further include a registration information provision unit for creating second membership registration information for the store based on location information of the user when the store is an unaffiliated store that does not correspond to any one of the first type, the second type, and the third type, and providing the second membership registration information to the terminal; and a second membership registration unit for registering the store as the second membership store when receiving a request to register for a second membership based on the second membership registration information from the terminal.

Here, the second membership points may be used in the multiple first membership stores.

Also, a method for managing a membership according to the present invention includes receiving information about a store used by a user from a terminal of the user and checking whether the store is a first membership store; checking whether the store is a second membership store registered by the user; updating current states of use of respective second membership stores based on a use record of the user when the store does not correspond to the first membership store but is the second membership store; and recommending a store satisfying a condition for recommendation as a first membership store, among multiple second membership stores registered in a store database, based on the current states of use of the respective second membership stores.

Here, the method may further include providing a membership service and a membership advertisement to the terminal when the store is a first type corresponding only to the first membership store, the membership advertisement being created so as to correspond to multiple first membership stores registered in the store database; providing the membership advertisement and second membership points to the terminal when the store is a second type corresponding only to the second membership store; and providing the membership service, the membership advertisement and the second membership points to the terminal when the store is a third type corresponding to both the first membership store and the second membership store.

Here, recommending the store may be configured to select the store recommended as the first membership store from among the second membership stores corresponding to the second type.

Here, the method may further include generating first membership recommendation content corresponding to the store recommended as the first membership store using the current states of use of the respective second membership stores, and providing the first membership recommendation content to the store recommended as the first membership store.

Here, providing the first membership recommendation content may be configured to provide the store recommended as the first membership store with statistical information about customers of the store recommended as the first membership store and an advertising and marketing tool for the store recommended as the first membership store.

Here, the method may further include creating second membership registration information for the store based on location information of the user when the store is an unaffiliated store that does not correspond to any one of the first type, the second type, and the third type, and providing the second membership registration information to the terminal; and registering the store as the second membership store when receiving a request to register for a second membership based on the second membership registration information from the terminal.

Here, the second membership points may be used in the multiple first membership stores.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram that shows a membership management system according to an embodiment of the present invention;

FIG. 2 is a block diagram that shows an example of the membership management server illustrated in FIG. 1;

FIG. 3 is a view that shows an example of a screen provided when joining a membership service according to the present invention;

FIG. 4 and FIG. 5 are views that show an example of a screen provided when registering for a second membership according to the present invention;

FIG. 6 and FIG. 7 are views that show a screen on which second membership stores are listed and a screen on which records on the use of a store are listed according to the present invention;

FIG. 8 is a view that shows an example of a membership service according to the present invention;

FIG. 9 is a view that shows an example of a membership advertisement according to the present invention;

FIG. 10 is a view that shows an example of statistical information about customers who use a store recommended as a first membership store according to the present invention;

FIG. 11 is a flowchart that shows a membership management method according to an embodiment of the present invention;

FIG. 12 is a flowchart that shows a process that differs depending on the type of store in a membership management method according to an embodiment of the present invention;

FIG. 13 is a flowchart that shows the process of recommending a store as a first membership store in a membership management method according to an embodiment of the present invention; and

FIG. 14 is a flowchart that shows the process of registering a store as a first membership store in a membership management method according to an embodiment of the present invention.

### DESCRIPTION OF THE PREFERRED EMBODIMENTS

Hereinafter, a preferred embodiment of the present invention is described in detail with reference to the accompanying drawings. However, in the following description and the accompanying drawings, detailed descriptions of known functions and configurations deemed to make the gist of the present invention obscure will be omitted. Also, it should be understood that the same reference numerals are used to designate the same or similar elements throughout the drawings. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Terms or words used in this specification and claims should not be interpreted according to typical or dictionary meanings, but should be interpreted as having meanings and concepts adapted to the technical idea of the present invention based on the principle that an inventor may properly define the concept of the terms in order to explain the present invention in the best way. Therefore, embodiments disclosed in this specification and configurations illustrated in the drawings are merely preferred embodiments of the present invention and do not fully describe the technical idea of the present invention, and thus there may be various equivalents and alterations replacing them at the filing date of the present application. Also, it will be understood that, although the terms “first”, “second”, etc. may be used herein to describe various elements, these elements should not be limited by these terms. These terms are only used to distinguish one element from another.

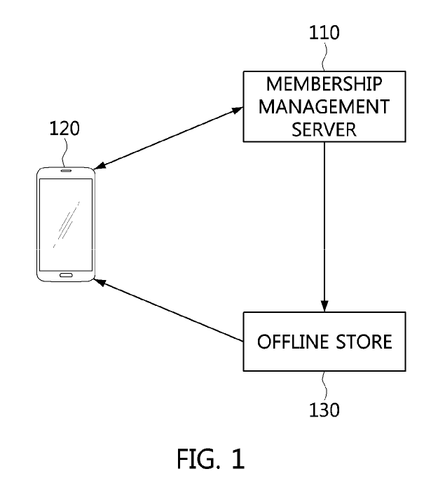

FIG. 1 is a block diagram that shows a membership management system according to an embodiment of the present invention.

Referring to FIG. 1, a membership management system according to an embodiment of the present invention includes a membership management server 110, a terminal 120 and an offline store 130.

The membership management server 110 receives information about a store used by a user from the terminal 120 of the user and checks whether the offline store 130 is a first membership store.

Also, the membership management server 110 checks whether the offline store 130 is a second membership store, which is registered by the user.

Also, if the offline store 130 is a second membership store not corresponding to a first membership store, the membership management server 110 updates the current states of use of respective second membership stores based on records on the use of the store.

Also, the membership management server 110 recommends a store that satisfies a condition for recommendation as a first membership store based on the current states of use of the respective second membership stores, among multiple second membership stores registered in a store database.

Also, the membership management server 110 provides a membership service and a membership advertisement for multiple first membership stores to the terminal 120 when the offline store 130 is a first type, provides the membership advertisement and second membership points to the terminal 120 when the offline store 130 is a second type, and provides the membership service, the membership advertisement, and the second membership points to the terminal 120 when the offline store 130 is a third type.

Here, the second membership points may be used in the multiple first membership stores.

Here, when the offline store 130 corresponds only to a first membership store, it is determined that the offline store 130 is the first type, and when the offline store 130 corresponds only to a second membership store, it is determined that the offline store 130 is the second type. Also, when the offline store 130 corresponds to both a first membership store and a second membership store, it is determined that the offline store 130 is the third type.

Here, a store, selected from among the second membership stores corresponding to the second type, may be recommended as a first membership store.

Also, using the current states of use of the respective second membership stores, the membership management server 110 creates first membership recommendation content for the store recommended as a first membership store and provides the created first membership recommendation content to the store recommended as a first membership store.

Here, statistical information about customers of the store recommended as a first membership store and an advertising and marketing tool for the store recommended as a first membership store may be provided thereto.

Also, when the offline store 130 is an unaffiliated store not corresponding to any one of the first, second and third types, the membership management server 110 creates second membership registration information for the offline store 130 based on location information of the user and provides the second membership registration information to the terminal 120.

Also, when it receives a request to register the store for a second membership based on the second membership registration information from the terminal 120, the membership management server 110 registers the offline store 130 as a second membership store.

The terminal 120 receives a screen that appears when a membership application executes on the membership management server 110 and provides the screen to the user.

Also, the terminal 120 is a device on which a membership application can run by being connected to a communication network, and may be one of various terminals such as all data communication devices, multimedia terminals, Internet Protocol (IP) terminals, and the like, without limitation to a mobile communication terminal. Also, the terminal 120 may be a mobile terminal having various mobile communication capabilities, such as a mobile phone, a Portable Multimedia Player (PMP), a Mobile Internet Device (MID), a smartphone, a tablet PC, a notebook computer, a netbook, a Personal Digital Assistant (PDA), a smart TV, a data communication device, and the like.

Also, the terminal 120 may deliver various kinds of information input by a user, such as numbers, characters, and the like, and signals that are input in order to set and control various functions of the terminal 120 to a control unit via an input unit. Here, the input unit of the terminal 120 may be configured to include at least one of a keypad and a touch pad, which generate an input signal in response to the touch or manipulation by a user. Here, the input unit of the terminal 120 may be configured in the form of a single touch panel (or a touch screen) by being integrated with a display unit thereof, whereby input and display functions may be performed through a single unit. Also, in addition to input devices such as a keyboard, a keypad, a mouse, a joystick, and the like, all forms of input units that have yet to be developed may be used as the input unit of the terminal 120. Particularly, the input unit of the terminal 120 according to the present invention may deliver a signal that is input in order to join a membership service or to register a store as a new second membership store to the control unit of the terminal 120.

Also, the display unit of the terminal 120 may display information about states and results of operations while the functions of the terminal 120 are being performed. Also, the display unit of the terminal 120 may display the menu items of the terminal 120, user data input by a user, and the like. Here, the display unit of the terminal 120 may be configured with a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when the display unit of the terminal 120 is configured in the form of a touch screen, the display unit of the terminal 120 may perform some or all of the functions of the input unit of the terminal 120. Particularly, the display unit of the terminal 120 according to the present invention may display information related to processing of a membership service and a membership advertisement on the screen.

Also, a storage unit of the terminal 120, which is a device for storing data, may include a main memory device and an auxiliary memory device, and may store applications required for performing the functions of the terminal 120. The storage unit of the terminal 120 may include a program area and a data area. Here, when a function is enabled in response to a request from a user, the terminal 120 provides the function by running a corresponding application under the control of the control unit. Particularly, the storage unit of the terminal 120 according to the present invention may store an operating system (OS) related to a process of booting the terminal 120, a membership application, and the like. Also, the storage unit of the terminal 120 may store a content DB, in which multiple pieces of content are stored, and information about the terminal 120. Here, the content DB contains executable data for executing content, attribute information about the content, information about the use of the content in connection with the execution of the content, and the like. Also, the information about the terminal 120 may include the specifications of the terminal.

Also, a communication unit of the terminal 120 may perform a function for sending and receiving data to and from the membership management server 110 via a network. Here, the communication unit of the terminal 120 may include an RF transmission means for performing up-conversion and amplification of the frequency of a signal to be transmitted and an RF reception means for performing low-noise amplification on a received signal and performing down-conversion on the frequency of the received signal. The communication unit of the terminal 120 may include at least one of a wireless communication module and a wired communication module. Here, the wireless communication module is a component for sending and receiving data according to a wireless communication method. When the terminal 120 uses wireless communication, the terminal 120 may send and receive data to and from the membership management server 110 using any one of a wireless network communication module, a wireless LAN communication module, and a wireless PAN communication module. That is, the terminal 120 may access a network using the wireless communication module, and may send and receive data to and from the membership management server 110 via the network. Particularly, the network according to the present invention enables the membership management server 110 and the terminal 120 to communicate with each other, whereby they may send and receive service and advertisement data for a membership.

Also, the control unit of the terminal 120 may be a processing device for running an OS and operating respective components. For example, the control unit may control the overall process of accessing the membership management server 110. When the membership management server 110 is accessed through a special service application, the control unit may control the process of running the application in response to a request from a user, and may send a request to use a service to the membership management server 110 when running the application. In this case, the control unit may perform control so that information required for user authentication is sent along with the request to use the service.

Also, the control unit of the terminal 120 may execute specific content stored in the storage unit of the terminal 120 in response to a request from a user. Here, when the content is executed, the control unit may store the record on the use of the content as content usage information.

The offline store 130 may have a communication device for performing short-range communication with the terminal 120 of a user.

For example, a beacon using Bluetooth Low Energy (BLE) may be used to provide various application services, such as recognition of objects and a situation, content push, indoor localization, automatic check-in, geo-fencing, and the like. Also, a beacon may mean a device for periodically transmitting a signal for giving certain information. Such a beacon may be classified into a sound-based low-frequency beacon, an LED beacon, a Wi-Fi beacon, a Bluetooth beacon, and the like, based on a method for transmitting signals. Also, a beacon may periodically transmit a signal using a small-sized packet, which is about 21 bytes, without the need to pair with a target device for receiving the signal, and may transmit a signal, which corresponds to the ID value of the beacon transmitter and received signal strength, over distances of up to 50 m, even though it operates with low power. Also, because such a beacon is small and inexpensive, it is easily fixed anywhere. Therefore, the beacon may be freely used anywhere in the offline store 130.

Also, although not illustrated in FIG. 1, the membership management system according to an embodiment of the present invention may include a network. Here, the network provides a route through which data may be exchanged between the membership management server 110, the terminal 120, and the offline store 130, and may be conceptually understood as including networks that are currently being used and networks that have yet to be developed. For example, the network may be any one of wired and wireless local area networks for providing communication between various kinds of data devices in a limited area, a mobile communication network for providing communication between mobile devices or between a mobile device and the outside thereof, a satellite network for providing communication between earth stations using a satellite, and a wired and wireless communication network, or may be a combination of two or more selected therefrom. Meanwhile, a transmission protocol standard for the network is not limited to existing transmission protocol standards, but may include all transmission protocol standards to be developed in the future. Also, in FIG. 1, the network used between the membership management server 110 and the terminal 120 may differ from the network used between the terminal 120 and the offline store 130, but may be identical to the network used between the terminal 120 and the offline store 130.

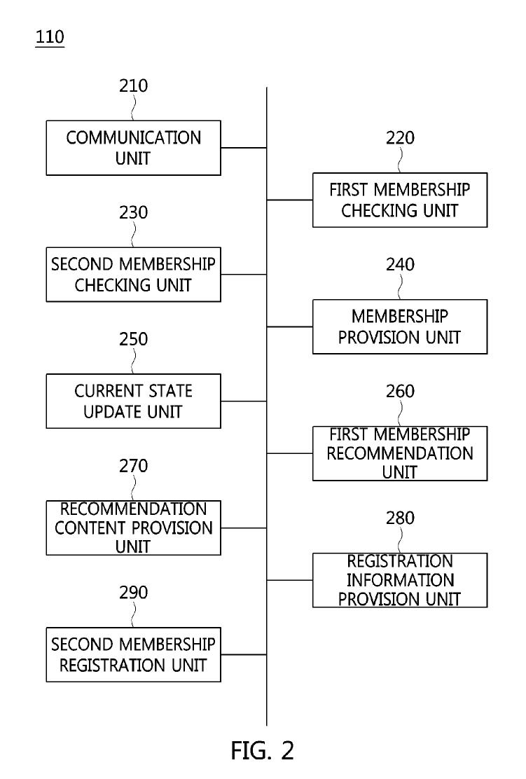

FIG. 2 is a block diagram that shows an example of the membership management server illustrated in FIG. 1.

Referring to FIG. 2, the membership management server 110 illustrated in FIG. 1 includes a communication unit 210, a first membership checking unit 220, a second membership checking unit 230, a membership provision unit 240, a current state update unit 250, a first membership recommendation unit 260, a recommendation content provision unit 270, a registration information provision unit 280, and a second membership registration unit 290.

The communication unit 210 serves to send and receive information that is necessary to manage the terminal of a user and a membership via a communication network. Particularly, the communication unit 210 according to an embodiment of the present invention may receive information about a store from the terminal of the user and provide a membership service, a membership advertisement, and the like to the terminal of the user.

The first membership checking unit 220 receives information about the store used by a user from the terminal of the user and checks whether the store is a first membership store.

Here, the information about the store may be obtained in such a way that the terminal of the user receives a signal including store information from a wireless local area communication device located in the store. For example, a BLE beacon may transmit a signal including information about a store to the terminal of the user who enters the store. Alternatively, when the user moves near a point of sale (POS) in order to buy a product in the store, information about the store may be obtained through a wireless local area communication device installed near the POS.

Here, information about the store may be the name, the identifier, the location information, the address, the telephone number, and the like of the store. Accordingly, a store database, in which information about multiple stores is stored, is searched for the store by inputting the store information, whereby whether the corresponding store is registered as a first membership store may be checked.

The second membership checking unit 230 checks whether the store used by the user is a second membership store registered by the user.

Here, a second membership store is registered for the second membership by a user rather than a membership provider, and may be a store that the user registers using a membership application in order to save points in the corresponding store, which is frequently used by the user. That is, when the user uses a second membership store, the corresponding store or the membership provider does not provide a partnership service or a membership service, but a record on the use of the second membership store is recorded in the terminal of the user and the benefits of saving points may be provided to the user.

Here, whether the store has been registered as a second membership store may be checked by inputting information about the store and searching the store database for the store, in the same way as checking whether the store is a first membership store.

Here, the store database may store and manage information about the stores registered as first membership stores and the stores registered as second membership stores. For example, stores may be categorized into first membership stores and second membership stores, and the first membership stores and the second membership stores may be stored separately. Also, the store database may be used to search for a store using the name, the location information, the address, the telephone number, and the like thereof and to search for the registration information and log pertaining to the found store.

The membership provision unit 240 provides a membership service and a membership advertisement for multiple first membership stores to a terminal when the store is a first type, provides the membership advertisement and second membership points to the terminal when the store is a second type, and provides the membership service, the membership advertisement, and the second membership points to the terminal when the store is a third type.

Here, when the store corresponds only to a first membership store, the store is determined to be the first type, and when the store corresponds only to a second membership store, the store is determined to be the second type. Also, when the store corresponds to both a first membership store and a second membership store, the store is determined to be the third type.

Here, the membership service may be a benefit, such as a discount coupon, a free event, and the like, provided by the store. For example, when a store affiliated with a membership provider delivers a discount coupon, event information, and the like to the membership provider, the membership provider may provide such a membership service to the terminal of the user who visits the store, using the membership management server.

Here, the membership advertisement may be an advertisement for first membership stores, which are the stores affiliated with the membership provider. Accordingly, users may be required to receive the membership advertisement for the first membership stores affiliated with the membership provider in return for receiving the benefits of saving second membership points in the store that they registered as a second membership store.

Here, the second membership points may be used in the multiple first membership stores, and may be saved when a user uses a second membership store or when the user registers a store as a new second membership store. In this case, the preset number of second membership points may be saved whenever a second membership store is used and whenever a store is registered as a new second membership store. For example, the number of points to be saved may be set such that 10 points are saved whenever a second membership store is used, and such that 50 points are saved whenever a store is registered as a new second membership store. Here, the number of points to be saved may be freely changed by a membership provider.

Here, if a store registered as a second membership store by a user is affiliated with first membership stores, the store may correspond to both a first membership store and a second membership store, that is, the store may correspond to the third type. In other words, if a certain store corresponding to a second membership store has a large number of customers, a membership provider invites the store to join as a member, whereby the store may also be registered as a first membership store.

Therefore, such a third type of store may provide a user with a membership service, which is provided because the store is registered as a first membership store, as well as the membership advertisement and the second membership points, which have been provided to the terminal since the store was registered as a second membership store.

The current state update unit 250 updates current states of use of the respective second membership stores based on the record on the use of a store when the store used by the user is a second membership store not corresponding to a first membership store.

Here, the current states of use of the respective second membership stores may include information, such as the accumulated number of users, the average daily number of users, and the number of users broken down by sex or age for each of the second membership stores, the date on which the store was registered as a second membership store, and the like. Here, the number of users broken down by sex or age may be obtained based on user information, such as sex, age, and the like, which was input when a user joined a membership service.

Accordingly, whenever the user who has joined a membership service uses the second type of store corresponding only to a second membership store, the current states of use of the respective second membership stores are updated, whereby up-to-date information may be maintained.

The first membership recommendation unit 260 recommends a store that satisfies a condition for recommendation as a first membership store, among the multiple second membership stores registered in the store database, based on the current states of use of the respective second membership stores.

Here, the condition for recommendation may be generated based on at least one of the accumulated number of users, the number of users who registered a store as a second membership store, and the average daily number of users for each of the stores.

For example, whether the accumulated number of users has reached 5000 one year after a store has been registered as a second membership store may be set as the condition for recommendation. Accordingly, stores the registration date of which more than one year in the past are extracted from the multiple second membership stores registered in the store database, and among the extracted stores, stores of which the accumulated number of users is greater than 5000 may be recommended as first membership stores.

In another example, whether the elapsed time since a store was registered is greater than a year and whether the average daily number of users of the store is equal to or greater than 30 may be set as the conditions for recommendation.

Here, the store recommended as a first membership store may be selected from among the second membership stores corresponding to the second type. That is, the store recommended as a first membership store may be selected from the stores that have become the second membership stores but have not yet become the first membership stores.

Here, the second type of second membership stores corresponding to the area and business type desired by a membership provider are extracted from the store database based on store information, such as the location, the address, the business type, and the like of the second membership stores, and stores selected from among the extracted second membership stores may be recommended as first membership stores.

For example, when districts are divided based on a town or a village, if a relatively small number of first membership stores is present in district ‘A’ compared to other districts, the second type of second membership stores in district ‘A’ are extracted from the store database, and then a store selected from among the extracted second type of second membership stores in district ‘A’ may be recommended as a first membership store. Here, if there is no store that satisfies the current condition for recommendation, the condition for recommendation may be eased depending on the situation, whereby a store satisfying the eased condition may be recommended as a first membership store.

The recommendation content provision unit 270 creates first membership recommendation content corresponding to the store recommended as a first membership store using the current states of use of the respective second membership stores and provides the first membership recommendation content to the store recommended as a first membership store.

Here, the first membership recommendation content may be delivered to the owner of the store recommended as a first membership store using data communication, or a membership provider may visit the store recommended as a first membership store and deliver the first membership recommendation content to the owner of the store.

Here, the statistical information about the customers of the store recommended as a first membership store and an advertising and marketing tool customized for the store may be provided thereto.

Here, the statistical information about customers may be generated by extracting information from the current states of use of the respective second membership stores. Therefore, the statistical information about customers may include information about the accumulated number of users, the average daily number of users, the distribution of users according to age and sex, and the like for the store recommended as a first membership store. Accordingly, the owner of the store recommended as a first membership store may easily check which customers use the store and the usage rate based on this statistical information.

Also, based on the statistical information about customers, an advertising and marketing tool suitable for the store recommended as a first membership store is provided together with the statistical information, whereby a method for increasing the profits of the store may be provided to the owner of the store.

Through this process, the membership provider registers the profit-making store as a membership store and thereby earns membership fees, and the owner of the store newly registered as a first membership store provides a customized advertisement to the customers of the store, along with unbiased information on the use of the store, whereby an increase in the profits of the store can be expected.

The registration information provision unit 280 generates second membership registration information for a store based on the location information of a user when the store is an unaffiliated store not corresponding to any one of the first, second, and third types, and provides the second membership registration information to the terminal.

Here, in order to prevent error in registering the store for a second membership and malicious use thereof, whether the store information acquired from the user matches the store corresponding to the location information of the user is checked, and when the store information acquired from the user matches the store corresponding to the location information of the user, the second membership registration information may be generated.

Here, the second membership registration information may be generated based on information such as the name, the telephone number, the location, and the like of the store to be registered, and may be delivered to and output in the terminal of the user.

When it receives a request to register for the second membership based on the second membership registration information from the terminal, the second membership registration unit 290 registers the store as a second membership store. That is, when the user performs input for registration after checking store information output in the display of the terminal, the membership management server receives the request to register for the second membership as the result of input by the user and registers the store as a second membership store.

Here, information about the second membership stores registered by an individual user may be provided to the terminal of the user. That is, because the second membership stores are registered by a user, respective users who use a membership service may have different second membership stores. Therefore, when a user searches for a second membership store using a terminal, second membership stores are retrieved from the store database based on the identifier of the terminal of the user, and information thereabout may be provided. Here, the record on the use of the respective second membership stores registered by the user may be provided together with the information about the found second membership stores.

Also, although not illustrated in FIG. 2, the membership management server 110 illustrated in FIG. 1 may include a storage unit.

The storage unit stores various kinds of information generated during the above-described process of managing a membership according to an embodiment of the present invention.

According to an embodiment, the storage unit may be configured to be separate from the membership management server 110 and support a function for managing a membership. Here, the storage unit may operate as separate mass storage, and may include a control function for performing operations.

Meanwhile, the membership management server 110 may include memory, and information may be stored therein. In an embodiment, the memory is a computer-readable recording medium. The memory may be a volatile memory unit in an embodiment, or the memory may be a non-volatile memory unit in another embodiment. In an embodiment, a storage device is a computer-readable recording medium. In different embodiments, the storage device may include, for example, a hard disk device, an optical disk device, or any other kind of mass storage device.

Using this membership management server, a store that is recommended based on the records on the customers' actual use of the stores may be registered as a membership store, whereby membership advertisements and service may be more effectively used.

Also, membership benefits may be provided to users in a store that does not provide a membership service but is often used by a user, and the owner of the store receives a marketing and advertising tool specialized for the store from a membership provider and provides better services to customers, whereby the sales and profits of the store may be increased.

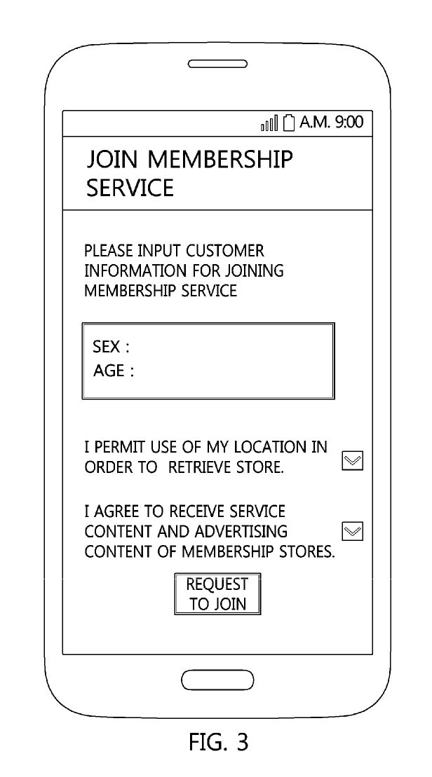

FIG. 3 is a view that shows an example of a screen provided when joining a membership service according to the present invention.

Referring to FIG. 3, when a user joins a membership service according to the present invention, information such as the sex, age, and the like of the user may be acquired as user information. Here, information about the terminal of the user, for example, the identifier and the device type of the terminal, may also be acquired as the user information, and the user information may be transmitted to a membership management server.

Here, it is necessary to inform the user of the purpose of the use of information about the current location of the user and to obtain the user's approval for the use thereof in order to use the location information for verification, which is required when the user who has joined the membership service registers a store as a second membership store. Also, when the user uses the store that the user registered as a second membership store, because a membership advertisement for first membership stores is provided to the terminal of the user along with second membership points, it is necessary to obtain the user's approval for the reception of the membership advertisement.

Also, it is necessary to obtain the user's approval for the reception of content corresponding to a membership service provided by a first membership store when the user uses the first membership store.

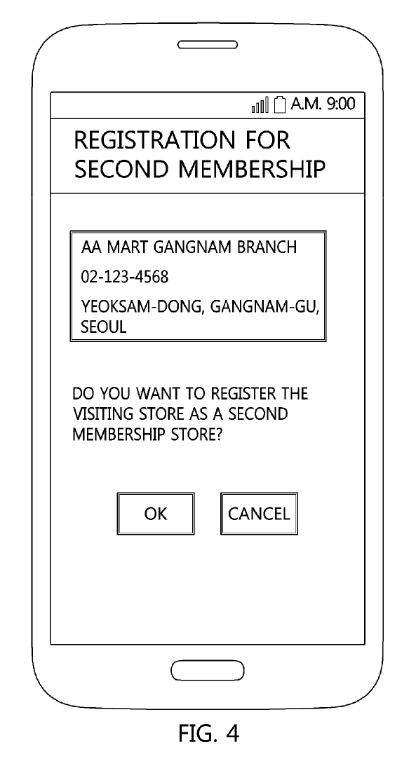

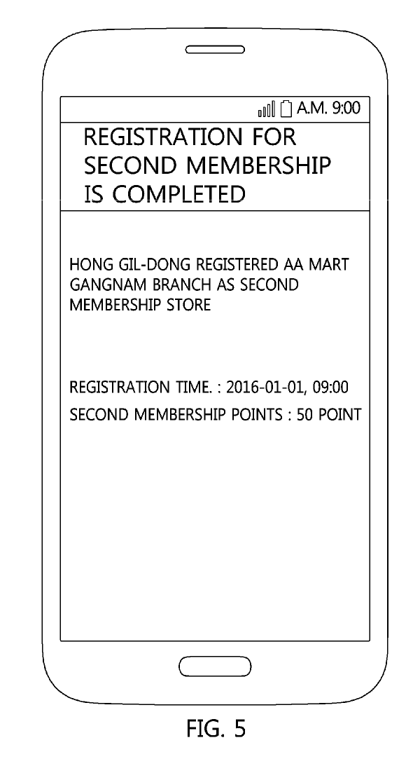

FIG. 4 and FIG. 5 are views that show an example of a screen provided when registering for a second membership according to the present invention.

Referring to FIG. 4 and FIG. 5, in order to register for a second membership according to the present invention, a user provides information about the store that the user is currently using to a membership management server, and the membership management server may determine whether the store can be registered for a membership based on the information about the store.

For example, if the store currently being used by the user is the second type, corresponding only to a second membership store, or if the store is the third type, corresponding to both a first membership store and a second membership store, the corresponding store cannot be registered again for the second membership. When the store currently being used by the user is the first type, corresponding only to a first membership store, or when the store is an unaffiliated store that is neither a first membership store nor a second membership store, the store can be registered for the second membership.

Here, the membership management server may verify whether the location of the store based on the store information provided from the user matches the current location of the user, determined using the terminal of the user, and may create second membership registration information required to register for the second membership when the verification succeeds because the two locations match each other. Through this verification process, error in registration for the second membership and registration by a malicious user may be prevented.

Here, the second membership registration information may be created based on information such as the name, the telephone number, and the address of the store, and may be output to the terminal of the user, as shown in FIG. 4.

Then, when the user checks the output information and touches the registration button in order to register the corresponding store as a second membership store, a request to register for the second membership is created in the terminal and delivered to the membership management server, whereby registration for the second membership may be completed.

Here, after registration for the second membership is completed, the membership management server may provide information about the completion of the registration for the second membership to the terminal of the user, as shown in FIG. 5.

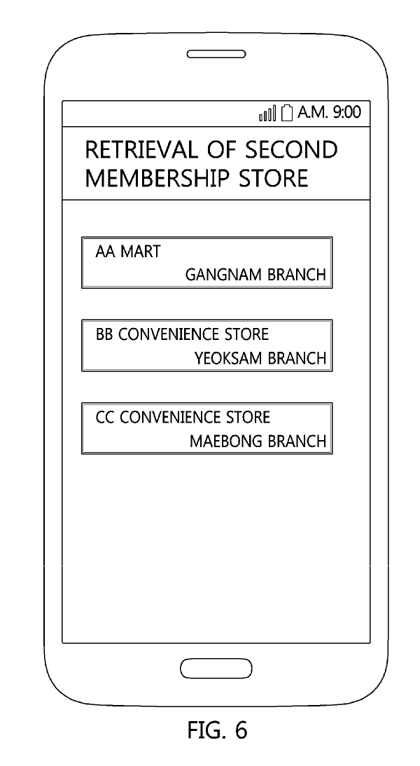

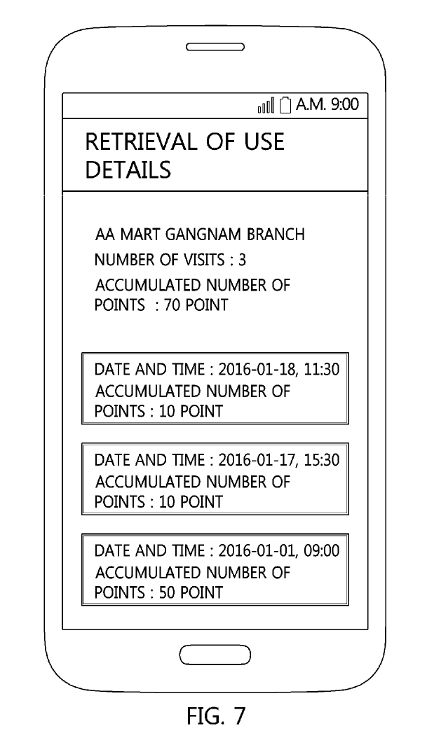

FIG. 6 and FIG. 7 are views that show a screen on which second membership stores are listed and a screen on which records on the use of a store are listed according to the present invention.

Referring to FIG. 6 and FIG. 7, the second membership stores registered by a user and the records on the use of the respective second membership stores may be retrieved using the terminal of the user according to the present invention.

For example, when a user searches for the second membership stores registered by the user, a membership management server may extract the second membership stores from a store database based on user information and output the extracted second membership stores to the terminal of the user so as to be displayed in the terminal, as shown in FIG. 6.

Here, information about the second membership stores output to the terminal of the user may be sorted based on the registration date, the number of times that the user uses a store, the current location of the user and the like. For example, the second membership stores may be sorted by the date on which a store was registered as a second membership store from the oldest to the newest, or may be sorted by the number of times that the user uses a store. In another example, the location of the user is acquired from the terminal of the user, and the second membership stores may be output after being sorted by the distance between the user and a store, in order from the nearest store to the farthest store.

Also, when a user searches for second membership stores and selects any one from among the found second membership stores, the record on the use of the corresponding store may be provided as shown in FIG. 7.

For example, assuming that a user selects “AA Mart Gangnam branch”, which is at the top of the list of the second membership stores illustrated in FIG. 6, the membership management server may output the record on the use of AA Mart Gangnam branch based on the current states of use of the respective second membership stores, as shown in FIG. 7. Here, the record on the use of the store may be output such that the number of times that the corresponding second membership store is used, the accumulated number of second membership points, and details of the use of the store, which are listed in the order of the date on which the store was visited, from the newest to the oldest.

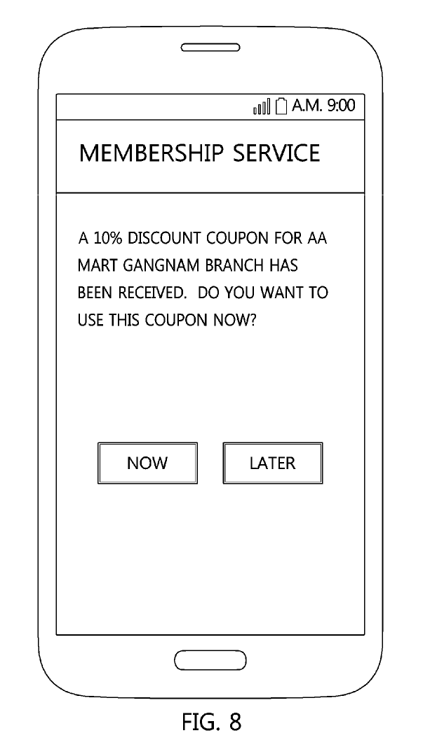

FIG. 8 is a view that shows an example of a membership service according to the present invention.

Referring to FIG. 8, a membership service according to the present invention may be provided to the terminal of a user, as shown in FIG. 8, when the user uses a first membership store.

Here, the membership service relates to benefits provided by the first membership store used by the user, and may correspond to, for example, a discount coupon that can be used in the first membership store or information about an event in the first membership store.

Here, buttons for selecting ‘now’ or ‘later’ are provided in order to enable the user to determine when to use the membership service provided to the terminal of the user, whereby the user may selectively use the corresponding membership service.

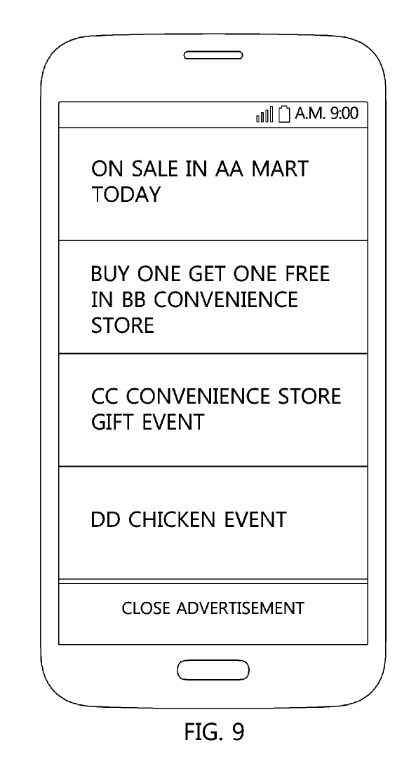

FIG. 9 is a view that shows an example of a membership advertisement according to the present invention.

Referring to FIG. 9, the terminal of a user may receive a membership advertisement according to the present invention when the user uses a first membership store or a second membership store.

Here, the membership advertisement may be an advertisement for the multiple first membership stores registered in the store database. That is, the user may be required to receive the membership advertisement provided by a membership provider in order to receive the benefits of saving second membership points when using a second membership store.

Here, the membership advertisement may be output such that the advertisement for the nearest first membership store tops the list of the membership advertisements based on the current location of the user.

Also, a membership advertisement corresponding to the business type that is frequently used by the user may be output so as to be at the top of the list based on the records on the use of the stores acquired from the user.

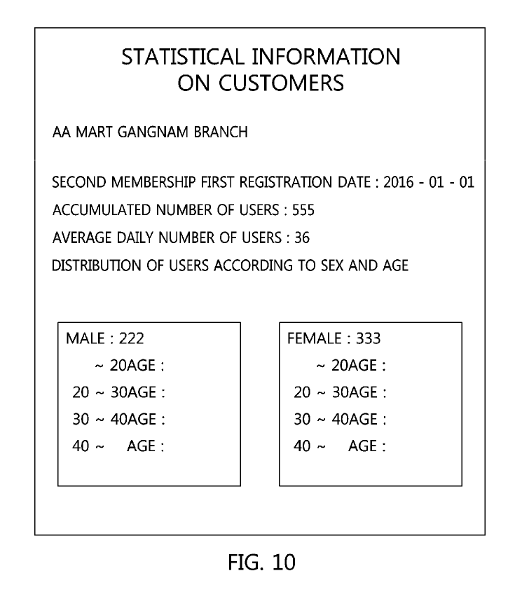

FIG. 10 is a view that shows an example of statistical information about customers of the store recommended as a first membership store according to the present invention.

Referring to FIG. 10, statistical information about the customers of the store recommended as a first membership store according to the present invention may include information through which the owner of the corresponding store may check the frequency of use of the store.

For example, the statistical information may include the accumulated number of users who have registered the recommended store as a second membership store and the average daily number of users, as shown in FIG. 10.

Also, because information about the distribution of users according to sex and age is provided based on user information, the owner of the store recommended as a first membership store may receive help when determining which customers will be the marketing target.

Here, the membership management server may generate a marketing and advertising tool customized for the store recommended as a first membership store based on the statistical information about the customers and provide it to the owner of the store, along with the statistical information.

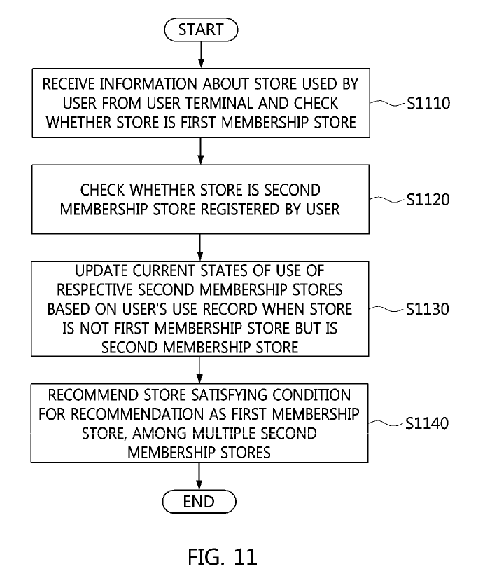

FIG. 11 is a flowchart that shows a method for managing a membership according to an embodiment of the present invention.

Referring to FIG. 11, in the method for managing a membership according to an embodiment of the present invention, information about the store used by a user is received from the terminal of the user, and whether the store is a first membership store is checked at step S1110.

Here, the information about the store may be acquired in such a way that the terminal of the user receives a signal including the information about the store from a wireless local area communication device located in the store. For example, a BLE beacon may transmit a signal including information about a store to the terminal of a user who is entering the store. Alternatively, when a user moves near a point of sales (POS) in order to buy a product in the store, information about the store may be acquired through a wireless local area communication device installed near the POS.

Here, information about the store may be the name, the identifier, the location information, the address, the telephone number, and the like of the store. Accordingly, a store database, in which information about multiple stores is stored, is searched for the store by inputting the store information, whereby whether the corresponding store is registered as a first membership store may be checked.

Also, in the method for managing a membership according to an embodiment of the present invention, whether the store used by a user is a second membership store registered by the user is checked at step S1120.

Here, a second membership store is registered for the second membership by a user rather than a membership provider, and may correspond to a store that the user registers using a membership application in order to save points in the corresponding store, which is frequently used by the user. That is, when the user uses a second membership store, the corresponding store or the membership provider does not provide a partnership service or a membership service, but a record on the use of the second membership store is recorded in the terminal of the user, and the benefits of saving points may be provided to the user.

Here, whether the store is registered as a second membership store may be checked by inputting information about the store and searching the store database for the store, in the same way as checking whether the store is a first membership store.

Here, the store database may store and manage information about the stores registered as first membership stores and the stores registered as second membership stores. For example, stores may be categorized into first membership stores and second membership stores, and the first membership stores and the second membership stores may be stored separately. Also, the store database may be used to search for a store using the name, the location information, the address, the telephone number, and the like thereof and to search for registration information and logs pertaining to the found store.

Also, although not illustrated in FIG. 11, in the method for managing a membership according to an embodiment of the present invention, a membership service and a membership advertisement for multiple first membership stores are provided to a terminal if a store is a first type, the membership advertisement and second membership points are provided to the terminal if the store is a second type, and the membership service, the membership advertisement, and the second membership points are provided to the terminal if the store is a third type.

Here, when the store corresponds only to a first membership store, the store is determined to be the first type, and when the store corresponds only to a second membership store, the store is determined to be the second type. Also, when the store corresponds to both a first membership store and a second membership store, the store is determined to be the third type.

Here, the membership service may be a benefit, such as a discount coupon, a free event, or the like, provided by the store. For example, when a store affiliated with a membership provider delivers a discount coupon, event information, or the like to the membership provider, the membership provider may provide such a membership service to the terminal of the user who visits the store, using the membership management server.

Here, the membership advertisement may be an advertisement for first membership stores, which are the stores affiliated with the membership provider. Accordingly, users may be required to receive the membership advertisement for the first membership stores affiliated with the membership provider in return for receiving the benefits of saving second membership points in the store that they registered as a second membership store.

Here, the second membership points may be used in the multiple first membership stores, and may be saved when a user uses a second membership store or when the user registers a store as a new second membership store. In this case, the preset number of second membership points may be saved whenever a second membership store is used and whenever a store is registered as a new second membership store. For example, the number of points to be saved may be set such that 10 points are saved whenever a second membership store is used, and such that 50 points are saved whenever a store is registered as a new second membership store. Here, the number of points to be saved may be freely changed by a membership provider.

Here, if a store registered as a second membership store by a user is affiliated with a first membership store, the store may be both a first membership store and a second membership store, that is, the store may be the third type. In other words, if a certain store corresponding to a second membership store has a large number of customers, a membership provider invites the store to join as a member, whereby the store may also be registered as a first membership store.

Therefore, such a third type of store may provide a user with a membership service, which is provided because the store is newly registered as a first membership store, as well as the membership advertisement and the second membership points, which have been provided to the terminal since the store was registered as a second membership store.

Also, in the method for managing a membership according to an embodiment of the present invention, if the store used by a user is a second membership store but is not a first membership store, the current states of use of the respective second membership stores are updated based on the record on the use of the store at step S1130.

Here, the current states of use of the respective second membership stores may include information such as the accumulated number of users, the average daily number of users, and the number of users broken down by sex or age for each of the second membership stores, the date on which the store was registered as a second membership store, and the like. Here, the number of users broken down by sex or age may be obtained based on user information, such as sex, age, and the like, which was input when a user joined the membership.

Accordingly, whenever the user who joined a membership service uses the second type of store, corresponding only to a second membership store, the current states of use of the respective second membership stores are updated, whereby up-to-date information may be maintained.

Also, in the method for managing a membership according to an embodiment of the present invention, among the multiple second membership stores registered in a store database, a store satisfying a condition for recommendation is recommended as a first membership store at step S1140 based on the current states of use of the respective second membership stores.

Here, the condition for recommendation may be generated based on at least one of the accumulated number of users, the number of users who registered a store as a second membership store, and the average daily number of users for each of the stores.

For example, whether the accumulated number of users has reached 5000 one year after a store has been registered as a second membership store may be set as the condition for recommendation. Accordingly, stores the registration date of which more than one year in the past are extracted from the multiple second membership stores registered in the store database, and among the extracted stores, stores of which the accumulated number of users is greater than 5000 may be recommended as first membership stores.

In another example, whether the elapsed time since a store was registered is greater than a year and whether the average daily number of users of the store is equal to or greater than 30 may be set as the conditions for recommendation.

Here, the store recommended as a first membership store may be selected from among the second membership stores corresponding to the second type. That is, the store recommended as a first membership store may be selected from the stores that have become second membership stores but have not yet become first membership stores.

Here, the second type of second membership stores corresponding to the area and business type desired by a membership provider are extracted from the store database based on store information, such as the location, the address, the business type, and the like of the second membership stores, and stores selected from among the extracted second membership stores may be recommended as first membership stores.

For example, when districts are divided based on a town or a village, if a relatively small number of first membership stores is present in district ‘A’ compared to other districts, the second type of second membership stores in district ‘A’ are extracted from the store database, and then a store selected from among the extracted second type of second membership stores in district ‘A’ may be recommended as a first membership store. Here, if there is no store that satisfies the current condition for recommendation, the condition for recommendation may be eased depending on the situation, whereby a store satisfying the eased condition may be recommended as a first membership store.

Also, although not illustrated in FIG. 11, in the method for managing a membership according to an embodiment of the present invention, first membership recommendation content corresponding to the store recommended as a first membership store is created using the current states of use of respective second membership stores, and the created first membership recommendation content is provided to the store recommended as a first membership store.

Here, the first membership recommendation content may be delivered to the owner of the store recommended as a first membership store using data communication, or a membership provider may visit the store recommended as a first membership store, and may deliver the first membership recommendation content to the owner of the store.

Here, statistical information about the customers of the store recommended as a first membership store and an advertising and marketing tool customized for the store may be provided to the store.

Here, the statistical information about customers may be generated by extracting information from the current states of use of the respective second membership stores. Therefore, the statistical information about customers may include information about the accumulated number of users, the average daily number of users, the distribution of users according to age and sex, and the like for the store recommended as a first membership store. Accordingly, the owner of the store recommended as a first membership store may easily check which customers use the store and the usage rate based on this statistical information.

Also, based on the statistical information about customers, an advertising and marketing tool suitable for the store recommended as a first membership store is provided together with the statistical information, whereby a method for increasing the profits of the store may be provided to the owner of the store.

Through this process, the membership provider registers the profit-making store as a membership store and thereby earns membership fees, and the owner of the store newly registered as a first membership store provides a customized advertisement to the customers of the store, along with unbiased information on the use of the store, whereby an increase in the profits of the store can be expected.

Also, although not illustrated in FIG. 11, in the method for managing a membership according to an embodiment of the present invention, if the store visited by a user is an unaffiliated store that does not correspond to any one of the first, second, and third types, second membership registration information is created for the store based on the location of the user, and the second membership registration information is provided to the terminal of the user.

Here, in order to prevent error in registering the store for a second membership and malicious use thereof, whether the store information acquired from the user matches the store corresponding to the location information of the user is checked, and when the store information acquired from the user matches the store corresponding to the location information of the user, the second membership registration information may be generated.

Here, the second membership registration information may be generated based on information such as the name, the telephone number, the location, and the like of the store to be registered, and may be delivered to and output in the terminal of the user.

Also, although not illustrated in FIG. 11, in the method for managing a membership according to an embodiment of the present invention, in response to a request to register a store for a second membership, which is based on the second membership registration information, from a terminal, the store is registered as a second membership store. That is, when the user performs input for registration after checking store information output in the display of the terminal, the membership management server receives the request to register for the second membership as the result of input by the user and registers the store as a second membership store.

Here, information about the second membership stores registered by an individual user may be provided to the terminal of the user. That is, because the second membership stores are registered by a user, respective users who use a membership may have different second membership stores. Therefore, when a user searches for a second membership store using a terminal, second membership stores are retrieved from the store database based on the identifier of the terminal of the user, and information thereabout may be provided. Here, the record on the use of the respective second membership stores registered by the user may be provided together with the information about the found second membership stores.

Also, although not illustrated in FIG. 11, in the method for managing a membership according to an embodiment of the present invention, the terminal of the user may send and receive information necessary for managing a membership via a network. Particularly, in the method for managing a membership according to the present invention, store information may be received from the terminal of a user, and a membership service, a membership advertisement, and the like may be provided to the terminal of the user.

Also, although not illustrated in FIG. 11, in the method for managing a membership according to an embodiment of the present invention, various kinds of information generated during the above-mentioned membership management process according to an embodiment of the present invention is stored.

Through the above-mentioned method for managing a membership, a frequently used store that is recommended based on the records on the customers' actual use of stores may be registered as a membership store, whereby membership advertisements and service may be more effectively used.

Also, membership benefits may be provided to users in a store that does not provide a membership service but is often used by a user, and the owner of the store receives a marketing and advertising tool specialized for the store from a membership provider and provides better services to customers, whereby the sales and profits of the store may be increased.

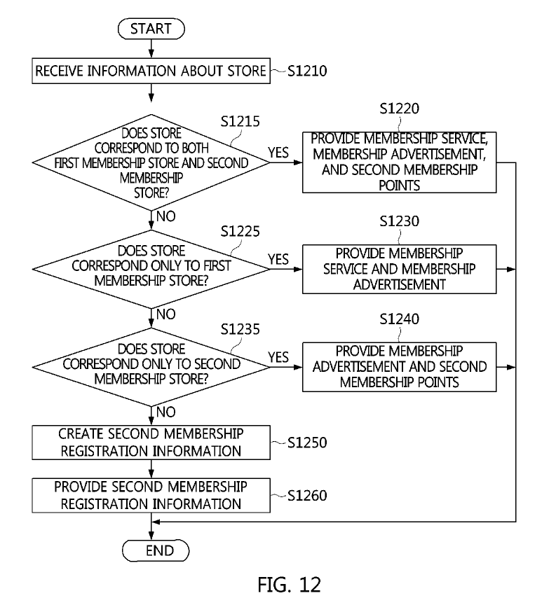

FIG. 12 is a flowchart that shows a process that differs depending on the type of store in the method for managing a membership according to an embodiment of the present invention.

Referring to FIG. 12, in the process that differs depending on the type of store in the method for managing a membership according to an embodiment of the present invention, information about the store used by a user may be received from the terminal of the user at step S1210.

Then, whether the store is the third type, which corresponds to both a first membership store and a second membership store, may be checked based on the store information at step S1215.

When it is determined at step S1215 that the store is the third type, a membership service, a membership advertisement for first membership stores, and second membership points may be provided to the terminal of the user at step S1220.

Conversely, when it is determined at step S1215 that the store is not the third type, whether the store is the first type, which corresponds only to a first membership store, may be checked at step S1225.

When it is determined at step S1225 that the store is the first type, a membership service and a membership advertisement may be provided to the terminal of the user at step S1230.

Conversely, when it is determined at step S1225 that the store is not the first type, whether the store is the second type, which corresponds only to a second membership store, may be checked at step S1235.

When it is determined at step S1235 that the store is the second type, a membership advertisement and second membership points may be provided to the terminal of the user at step S1240.

Conversely, when it is determined at step S1235 that the store is not the second type but is an unaffiliated store, second membership registration information is created at step S1250 based on the information about the store and is then provided to the terminal of the user at step S1260.

Here, the location of the store based on the store information provided by the user is compared with the current location of the terminal of the user, whereby verification may be performed before the creation of the second membership registration information. Here, when the verification succeeds because the two locations match each other, second membership registration information may be created, and registration for a second membership may be performed.

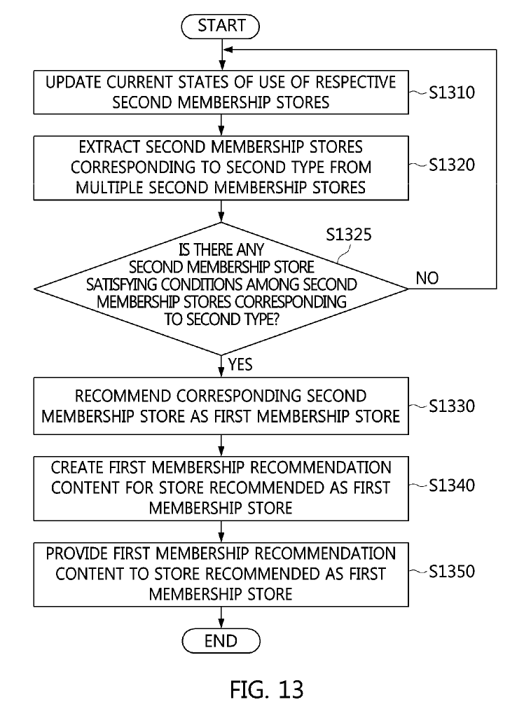

FIG. 13 is a flowchart that shows the process of recommending a store as a first membership store in the method for managing a membership according to an embodiment of the present invention.

Referring to FIG. 13, in the process of recommending a store as a first membership store in the method for managing a membership according to an embodiment of the present invention, first, the current states of use of respective second membership stores may be updated at step S1310 based on the record on the user's use of the second membership store, which does not correspond to a first membership store.

Then, second membership stores corresponding to the second type may be extracted from multiple second membership stores stored in the store database at step S1320.

Here, the second type indicates a second membership store not corresponding to a first membership store.

Then, whether there is a second membership store that satisfies a condition for recommendation, among the second membership stores corresponding to the second type, may be checked at step S1325.

When it is determined at step S1325 that there is no second membership store that satisfies the condition for recommendation, the reception of a record on the use of a store from a user is waited for again, and step S1310 may be performed upon receiving the record from the user.

Conversely, when it is determined at step S1325 that there is a second membership store that satisfies the condition for recommendation, the second membership store satisfying the condition may be recommended as a first membership store at step S1330.

Then, first membership recommendation content corresponding to the store recommended as a first membership store may be created at step S1340 based on the current states of use of the respective second membership stores.

Here, the first membership recommendation content may correspond to statistical information about customers of the store recommended as a first membership store and a marketing and advertising tool suitable for the store recommended as a first membership store.

Then, the first membership recommendation content may be provided to the store recommended as a first membership store at step S1350.

Here, the first membership recommendation content may be transmitted to the terminal of the store recommended as a first membership store or to the terminal of the owner of the store using a membership management server. Alternatively, a membership provider visits the store recommended as a first membership store and provides the first membership recommendation content.

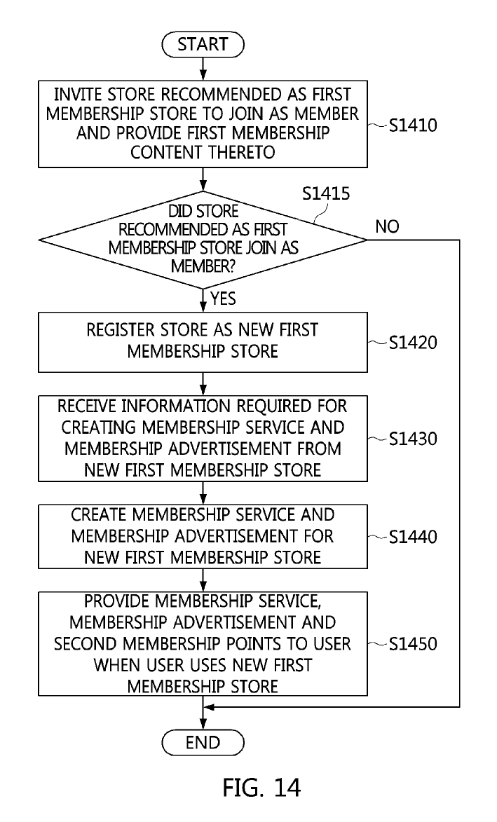

FIG. 14 is a flowchart that shows the process of registering a store as a first membership store in the method for managing a membership according to an embodiment of the present invention.

Referring to FIG. 14, in the process of registering a store as a first membership store in the method for managing a membership according to an embodiment of the present invention, first, the first membership recommendation content is provided to the store recommended as a first membership store, and the store recommended as a first membership store is invited to join as a member of first membership stores.

Here, the owner of the store recommended as a first membership store may determine whether to join as a member by analyzing the first membership recommendation content provided by a membership provider or a membership management server.

Then, it is determined at step S1415 whether the store recommended as a first membership store joins as a member of first membership stores, and the membership management server may register the store recommended as a first membership store as a new first membership store at step S1420 when it is determined that the store joins.

Here, the owner of the store registered as a new first membership store may pay a membership fee to the membership provider in return for the use of the membership service.

Then, the membership provider may receive information necessary for generating a membership service and a membership advertisement from the new first membership store at step S1430.

Then, at step S1440, the membership provider may generate a membership service to be provided to customers who use the new first membership store and a membership advertisement to be provided to customers who use at least one of multiple first membership stores and multiple second membership stores registered in the store database.

Then, when a user uses the new first membership store, the membership service, the membership advertisement, and second membership points may be provided to the terminal of the user at step S1450.

Also, when it is determined at step S1415 that the store recommended as a first membership store does not join as a member of first membership stores, the store may be invited to join later, or may not be invited to join, depending on the reason why the store refused to join.

The method for managing a membership according to the present invention may be implemented as program instructions that can be executed by various computer means and recorded in a computer-readable storage medium. In this case, the program instructions recorded on the computer-readable storage medium may include program instructions, data files, and data structures, either solely or in combination. The program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as CD-ROM and a DVD, magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

According to the present invention, because a store recommended based on records on the customers' actual use of the store is registered as an affiliate store, it is possible to make better use of membership advertisements and services.

Also, the present invention may provide users with membership benefits in stores that do not provide a membership service but are often visited by the users.

Also, the present invention provides an owner of a store with a marketing and advertising tool specialized for the store and enables the owner to provide better service to customers, whereby the sales and profits of the store may be increased.

According to the present invention, information about the store used by a user may be received from the terminal of the user, whether the store is a first membership store or a second membership store may be checked, the current states of use of respective second membership stores may be updated based on records on the use of the store when the store is a second membership store not corresponding to a first membership store, and a store that satisfies a condition for recommendation may be recommended as a first membership store based on the current states of use of the respective second membership stores, among the multiple second membership stores registered in a store database. Further, a user may receive benefits even when using a store that is not affiliated to a membership, a membership provider may establish an affiliation with a profit-making store by receiving information about the use of the store from the user, and the owner of the store may be provided with an advertising and marketing tool customized for the store by joining as a member.

As described above, a membership management system, a method for managing a membership using membership registration by a user, and an apparatus using the method according to the present invention are not limitedly applied to the configurations and operations of the above-described embodiments, but all or some of the embodiments may be selectively combined and configured, so that the embodiments may be modified in various ways.

What is claimed is:

1. A membership management server, comprising:
a first membership checking unit for receiving information about a store used by a user from a terminal of the user and checking whether the store is a first membership store;
a second membership checking unit for checking whether the store is a second membership store registered by the user;
a current state update unit for updating current states of use of respective second membership stores based on a use record of a user when the store does not correspond to the first membership store but is the second membership store; and
a first membership recommendation unit for recommending a store satisfying a condition for recommendation as a first membership store, among multiple second membership stores registered in a store database, based on the current states of use of the respective second membership stores.

2. The membership management server of claim 1, further comprising:
a membership provision unit for providing a membership service and a membership advertisement for multiple first membership stores to the terminal when the store is a first type, providing the membership advertisement and second membership points to the terminal when the store is a second type, and providing the membership service, the membership advertisement, and the second membership points to the terminal when the store is a third type.

3. The membership management server of claim 2, wherein the membership provision unit determines that the store is the first type when the store corresponds only to the first membership store, determines that the store is the second type when the store corresponds only to the second membership store, and determines that the store is the third type when the store corresponds to both the first membership store and the second membership store.

4. The membership management server of claim 2, wherein the first membership recommendation unit selects the store recommended as the first membership store from among the second membership stores corresponding to the second type.

5. The membership management server of claim 1, further comprising:
a recommendation content provision unit for generating first membership recommendation content corresponding to the store recommended as the first membership store using the current states of use of the respective second membership stores and providing the first membership recommendation content to the store recommended as the first membership store.

6. The membership management server of claim 5, wherein the recommendation content provision unit provides the store recommended as the first membership store with statistical information about customers of the store recommended as the first membership store and an advertising and marketing tool for the store recommended as the first membership store.

7. The membership management server of claim 2, further comprising:
a registration information provision unit for creating second membership registration information for the store based on location information of the user when the store is an unaffiliated store that does not correspond to any one of the first type, the second type, and the third type, and providing the second membership registration information to the terminal; and
a second membership registration unit for registering the store as the second membership store when receiving a request to register for a second membership based on the second membership registration information from the terminal.

8. The membership management server of claim 2, wherein the second membership points are capable of being used in the multiple first membership stores.

9. A method for managing a membership, comprising:
receiving information about a store used by a user from a terminal of the user and checking whether the store is a first membership store;
checking whether the store is a second membership store registered by the user;
updating current states of use of respective second membership stores based on a use record of the user when the store does not correspond to the first membership store but is the second membership store; and
recommending a store satisfying a condition for recommendation as a first membership store, among multiple second membership stores registered in a store database, based on the current states of use of the respective second membership stores.

10. The method of claim 9, further comprising:
providing a membership service and a membership advertisement to the terminal when the store is a first type corresponding only to the first membership store, the membership advertisement being created so as to correspond to multiple first membership stores registered in the store database;
providing the membership advertisement and second membership points to the terminal when the store is a second type corresponding only to the second membership store; and
providing the membership service, the membership advertisement and the second membership points to the terminal when the store is a third type corresponding to both the first membership store and the second membership store.
